(19) United States
(12) Patent Application Publication
(10) Pub. No.: US 2016/0115923 A1
(43) Pub. Date: Apr. 28, 2016

(54) METHOD FOR ACTUATING A CAMSHAFT

(71) Applicant: ROBERT BOSCH GMBH, Stuttgart (DE)

(72) Inventor: Thomas HERGES, Eberdingen (DE)

(21) Appl. No.: 14/894,082

(22) PCT Filed: May 15, 2014
(86) PCT No.: PCT/EP2014/059922

§ 371 Date: Nov. 25, 2015

(30) Foreign Application Priority Data
May 31, 2013 (DE) 10 2013 210 178.3

(51) Int. Cl. F02M 59/42; F02D 41/06; F02D 41/38; F02M 39/02

(52) U.S. Cl. CPC F02M 59/42; F02M 39/02; F02D 41/062; F02D 41/3845

(57) ABSTRACT

A method for actuating at least one camshaft, operable independently of a crankshaft, of an internal combustion engine includes: a) when the internal combustion engine is standing still, the at least one camshaft is actuated in such a way that a delivery stroke of a high-pressure pump of a high-pressure fuel injection device takes place; and b) during a subsequent reverse rotation of the at least one camshaft into the starting position, a quantity control valve of the high-pressure pump is not actuated.

### BACKGROUND OF THE INVENTION

1. Field of the Invention

The present invention relates to a method for actuating a camshaft of an internal combustion engine, said camshaft being operable independently of a crankshaft. The invention also relates to a computer program which is running on a computer element or control unit, in particular on a microprocessor. In addition, the present invention relates to a control unit, especially a control unit in a motor vehicle, which is equipped with means for actuating at least one camshaft, so that that a delivery stroke of a high-pressure pump of a high-pressure fuel injection device takes place.

2. Description of the Related Art

The published German patent application document DE 103 17 652 A1 describes a method for controlling a camshaft adjustment device, which makes it possible to operate a continuously variable camshaft adjustment device in an especially reliable and safe manner. To do so, the camshaft and the crankshaft are adjusted in such a way that a phase angle (actual value) of the camshaft in relation to the crankshaft is determined, the phase angle is monitored while the internal combustion engine is in operation and the camshaft adjustment device is regulated and/or controlled as a function of a variable setpoint value such that the phase angle corresponds to the setpoint value.

Such camshaft adjustment devices, for example, have the capability of electrically adjusting the camshaft. This makes it possible to adjust the camshaft independently of the crankshaft, i.e., in a manner that is decoupled from the crankshaft.

A method for operating an internal combustion engine is known from the published German patent application document DE 101 15 262 A1. A pressure accumulator, a high-pressure pump, a pressure sensor, and a quantity-control valve are provided. The camshaft can be operated independently of the crankshaft with the aid of a camshaft control unit.

The U.S. Pat. No. 6,318,343 B1 likewise describes a method for operating an internal combustion engine having a pressure accumulator, a pressure sensor of a high-pressure pump, and a camshaft adjustment device.

A method for adjusting a camshaft of an internal combustion engine equipped with a camshaft adjustment device is known from the published German patent application document DE 10 2008 008 117 A1. In this method, the camshaft is set from a stop setpoint position to a start setpoint position at the start.

None of these methods provide an operation of the camshaft while the internal combustion engine is standing still, in order to induce a delivery stroke of the high-pressure pump.

Current internal combustion engines are frequently set up for the direct injection of fuel. Such a direct fuel injection is used not only for diesel engines but also for Otto engines having direct injection. In the case of such internal combustion engines that have direct gasoline injection, the fuel for the injection is brought to a higher pressure level in a fuel distributor, also known as rail, in order to then be able to be injected into the combustion chamber by injectors. Once the internal combustion engine has been switched off, the pressure in the rail drops again, which means that in the following start the increased system pressure must first be generated again across a plurality of crankshaft rotations with the aid of a high pressure fuel pump (HPFP) during the starting process and is therefore unavailable for the first injections. The high-pressure fuel pump is usually installed on the camshaft and operated by a corresponding cam of the camshaft.

### BRIEF SUMMARY OF THE INVENTION

The method and the control unit according to the present invention make it possible to actuate the at least one camshaft and thus the HPP in a manner that ensures that high pressure is already present at the rail during the first injection, so that the first injections are already able to be used for operating the internal combustion engine. This improves the starting behavior of the internal combustion engine, and simultaneously results in a considerable reduction of the pollutant/particle emissions. The method according to the present invention for actuating at least one camshaft of an internal combustion engine, the camshaft being operable independently of a crankshaft, includes the following steps:

a) When the internal combustion engine is standing still, the at least one camshaft is actuated in such a way that a delivery stroke of a high-pressure fuel pump (HPP) of a high-pressure fuel injection device takes place;
b) In a subsequent reverse rotation of the at least one camshaft to the starting position, a quantity control valve of the high-pressure pump is closed, so that no return delivery takes place.

In so doing, the method utilizes the fact that the at least one camshaft is able to be actuated and operated, and thus adjusted, independently of the crankshaft. The control takes place in such a way that a delivery stroke of the at least one HPP installed on the at least one camshaft is carried out. Because of this delivery stroke, pressure is generated in the rail while the internal combustion engine is turned off. This pressure can be used for subsequent injection processes. The method may be used to particularly excellent advantage in system configurations having an increased number of starts, i.e., in hybrid vehicles, during what is known as “sailing mode”, or in an engine start-stop operation.

For example, it is advantageously provided to repeat method steps a) and b) multiple times, until the HPP has generated a predefinable pressure in the rail of the high-pressure fuel injection device.

The pressure is preferably acquired by a pressure sensor situated in the rail.

The at least one camshaft is preferably operated electrically.

In a control unit, the pressure acquired by the pressure sensor is compared to a predefined pressure. If the acquired pressure is lower than the predefined pressure, the electrical operation of the at least one camshaft is actuated, i.e., in such a way that a delivery stroke of the high-pressure pump takes place in order to increase the pressure in the rail in this manner. The method and the control unit thereby make it possible to increase the pressure in the rail to such a level that it can be used for a subsequent injection process when the internal combustion engine is deactivated.

This invention may be implemented in a particularly advantageous manner in the form of a computer program, the computer program being executable on a computer device or a control unit, particularly on a microprocessor, and suitable for executing the method according to the present invention. In this case, the invention is realized by the computer program so that this computer program represents the invention in the same manner as the method for whose execution the computer program is suitable. The computer program is preferably stored on a memory element. In particular a random access memory, a read only memory or a flash memory are used as storage elements, but CD-ROMs, DVD-ROMs or Blu-ray ROMs or also disk drives are usable as well. The realization in the form of a computer program furthermore has the great advantage that the method of the present invention is able to be “retrofitted” into existing internal combustion engines, so to speak. This is possible because pressure sensors, whose values are made available to the control unit, are already installed in virtually any internal combustion engine featuring high-pressure fuel injection devices. Additional hardware for executing the method of the present invention is not required. Instead, the method of the present invention may be used in connection with existing hardware and made to run thereon.

### BRIEF DESCRIPTION OF THE DRAWINGS

FIG. 1 shows a schematic representation of the components for actuating a camshaft.

FIG. 2 shows a simplified flow chart according to one specific development of the method according to the present invention.

### DETAILED DESCRIPTION OF THE INVENTION

Further features, uses and advantages of the present invention come to light from the following description of an exemplary embodiment of the invention which is shown in the drawing. For this purpose, all of the described or illustrated features form the subject of the present invention, either alone or in any combination, irrespective of their combination in the patent claims or their antecedent references and also irrespective of their individual wording and illustration in the description and in the drawing.

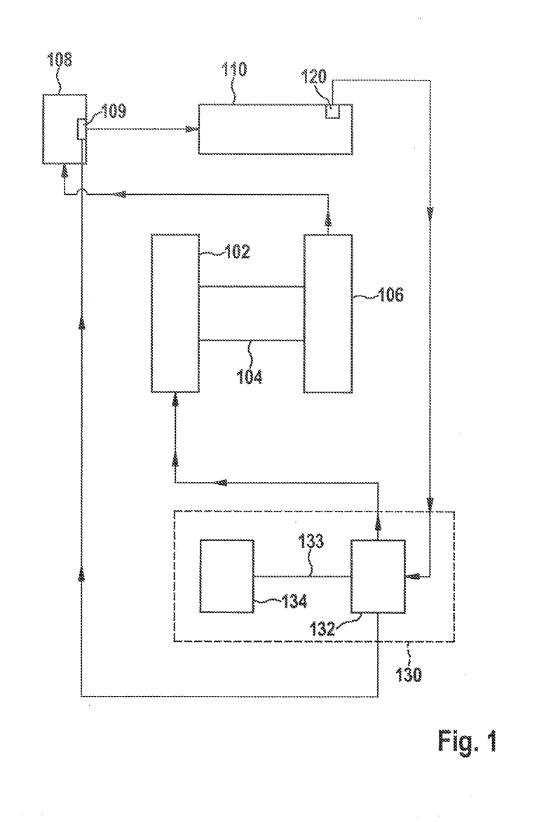

FIG. 1 schematically illustrates components used for controlling a camshaft adjustment device. Camshaft adjustment device 102 is situated on a camshaft 104. The adjustment device, for example, is an electric adjustment device, which allows a rotation of camshaft 104. Camshaft adjustment device 102 is actuated by a control device 130 in the manner that will be described in greater detail in the following text.

Hereinafter, the actuation of only a single camshaft is described, but the method is not restricted to such a type of actuation. It is also possible to actuate more than one camshaft in a corresponding manner.

The adjustment of camshaft 104, in particular, takes place independently of an adjustment or rotation of the crankshaft (not shown). In other words, camshaft 104 can be rotated independently of the crankshaft. In addition to controlling the intake and discharge valves by camshaft 104, camshaft 104 also controls a high-pressure fuel pump 108 of an internal combustion engine featuring a high-pressure fuel injection, using one or more cams 106 specially provided for this purpose. This high-pressure fuel pump 108 generates very high pressure in a fuel distributor 110, which is also referred to as rail. Lines branch off from this fuel distributor (rail) and lead to injection nozzles, which inject fuel under high pressure into the combustion chambers of the internal combustion engine (not shown) in a manner known per se.

A pressure sensor 120, whose output signals are transmitted to control device 130, is situated in rail 110. In a microprocessor 132 of control device 130, the acquired pressure of pressure sensor 120 is compared to a stored pressure value which is retrieved from a memory 134; if the pressure value lies below the pressure value retrieved from memory 134, an actuation of camshaft adjustment device 102 takes place and thus a rotation of camshaft 104 and cam 106, independently of a crankshaft position, in such a way that a delivery stroke of high-pressure pump 108 is triggered. When camshaft 104 is rotated back into the starting position, a quantity control valve 109 of high-pressure pump 108 will be closed. This actuation of quantity control valve 109, as well, is carried out by microprocessor 132 of control device 130. This closing of quantity control valve 109 ensures that no return delivery is generated.

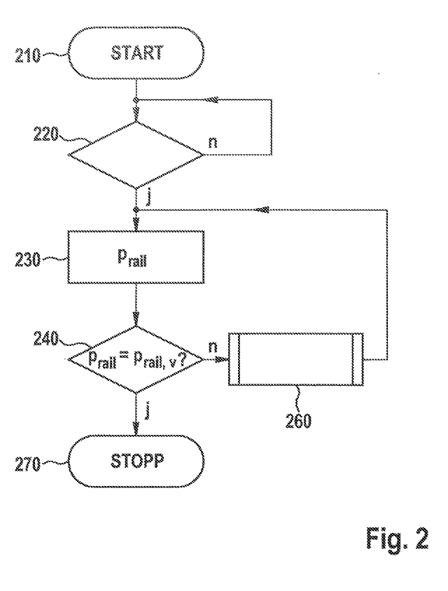

This method will be explained in the following text in conjunction with FIG. 2. Following a start 210, it is first queried in step 220 whether the internal combustion engine is at standstill, i.e., switched off. If this is not the case, a return to before step 220 takes place. However, if the internal combustion engine is standing still, pressure sensor 120 ascertains the pressure in the rail pᵣₐᵢₗ. This is done in step 230. In a step 240, it is then checked whether this acquired pressure pᵣₐᵢₗ is equal to a predefined rail pressure value p_{rail,v}. If this is the case, the method will be terminated at step 270. However, if this is not the case, branching into a subprogram 260 takes place. The afore-described actuation of camshaft 104 by camshaft adjustment device 102 occurs in this subprogram 260. This results in a rotation of camshaft 104 and thus of cam 106, i.e., in such a way that high-pressure pump 108 executes a delivery stroke and increases the pressure in rail 110. This pressure is detected by rail pressure sensor 120 and supplied to control device 130. Once the delivery stroke has occurred, quantity control valve 109 is closed in the manner described earlier, so that no return supply will be created. This maintains the pressure inside rail 110. Following the execution of this subprogram 260, a return to before step 230 is implemented, and a renewed detection of the rail pressure and a renewed comparison of the rail pressure to the predefined and stored rail pressure is carried out in step 240. In the event that the rail pressure that was predefined deviates from the measured pressure, i.e., is higher, subprogram 260 will be carried out again and another return to before step 230 be implemented. These steps are repeated until the measured rail pressure corresponds to the predefined rail pressure. Only then will a stop take place in step 270.

The method may be implemented as a computer program in the control unit, i.e., in microprocessor 132. For example, it can be stored in memory 134, which could be a flash player or some other storage medium. Of course, it is also possible that the program is supplied to and implemented in control unit 130 by an external storage medium. Purely as a matter of principle, it is also possible to develop control unit 130 as an electronic circuit, which executes precisely the aforementioned steps.

1-8. (canceled)

9. A method for actuating at least one camshaft of an internal combustion engine, the camshaft being operable independently of a crankshaft, the method comprising:
a) controlling, when the internal combustion engine is standing still, the at least one camshaft in such a way that a delivery stroke of a high-pressure fuel pump of a high-pressure fuel injection device takes place; and
b) closing, in a subsequent reverse rotation of the at least one camshaft into the starting position, a quantity control valve of the high-pressure pump.

10. The method as recited in claim 9, wherein the steps a) and b) are repeated multiple times, until the high-pressure pump has generated a predefined pressure in a rail of the high-pressure fuel-injection device.

11. The method as recited in claim 10, wherein the pressure in the rail is measured by a pressure sensor situated in the rail.

12. The method as recited in claim 10, wherein the at least one camshaft is actuated electrically.

13. The method as recited in claim 11, wherein the pressure measured by the pressure sensor in the rail is compared to the predefined pressure, and in the event of a deviation of the measured pressure from the predefined pressure, the at least one camshaft is actuated by a signal output by a control unit.

14. A non-transitory computer-readable data storage medium storing a computer program having program codes which, when executed on a computer, perform a method for actuating at least one camshaft of an internal combustion engine, the camshaft being operable independently of a crankshaft, the method comprising:
a) controlling, when the internal combustion engine is standing still, the at least one camshaft in such a way that a delivery stroke of a high-pressure fuel pump of a high-pressure fuel injection device takes place; and
b) closing, in a subsequent reverse rotation of the at least one camshaft into the starting position, a quantity control valve of the high-pressure pump.

15. A control unit for controlling at least one camshaft of an internal combustion engine which additionally has a crankshaft, the control unit comprising:
a camshaft adjustment device configured to enable an adjustment of the at least one camshaft independently of the crankshaft, wherein the at least one camshaft is actuated, when the internal combustion engine is standing still, by the camshaft adjustment device in such a way that a delivery stroke of a high-pressure pump of a high-pressure fuel injection device takes place, and a quantity control valve of the high-pressure pump is closed during the subsequent reverse rotation of the at least one camshaft.
